(19) United States
(12) Patent Application Publication
(10) Pub. No.: US 2016/0243524 A1
(43) Pub. Date: Aug. 25, 2016

(54) ABSORBENT AND METHOD OF MANUFACTURING THE SAME

(71) Applicant: AISAN KOGYO KABUSHIKI KAISHA, Obu-shi (JP)

(72) Inventor: Takashi MANI, Takahama-shi (JP)

(73) Assignee: AISAN KOGYO KABUSHIKI KAISHA, Obu-shi (JP)

(21) Appl. No.: 15/010,828

(22) Filed: Jan. 29, 2016

(30) Foreign Application Priority Data
Feb. 25, 2015 (JP) 2015-034937

(51) Int. Cl. B01J 20/28; B01J 20/30; B01J 20/20

(52) U.S. Cl. CPC B01J 20/28042; B01J 20/20; B01J 20/3078; B01J 20/3007

(57) ABSTRACT

An adsorbent includes three or more columnar portions. The three or more columnar portions are joined to each other at their lateral sides with their axial directions extending parallel to each other such that a hollow space having opposite axial open ends and a closed lateral side closed by the lateral sides of the three or more columnar portions is defined between the three or more columnar portions.

### CROSS-REFERENCE TO RELATED APPLICATIONS

This application is based upon and claims priority to Japanese Patent Application Serial No. 2015-034937 filed on Feb. 25, 2015, the contents of which are incorporated herein by reference in their entirety for all purposes.

### STATEMENT REGARDING FEDERALLY SPONSORED RESEARCH OR DEVELOPMENT

Not applicable.

### BACKGROUND

The disclosure generally relates to adsorbent that may be used for adsorbing fuel vapor produced in a fuel tank of a vehicle. The disclosure also relates to a method of manufacturing the adsorbent.

In a vehicle using a gasoline engine as a drive source, fuel vapor produced in a fuel tank may be adsorbed by adsorbent contained in a canister, so that the fuel vapor can be recovered. When the engine is operated, fuel vapor adsorbed by the adsorbent may be desorbed by a negative pressure called an “engine negative pressure” so as to be purged to the engine. Typically, the adsorbent may be activated carbon in forms of cylindrical pellets filled within the canister. If the activated carbon pellets are filled within the canister in a high density, a resistance against flow of gas (i.e., air) through the canister may increase. Therefore, JP-A-2013-11243 proposes to form activated carbon pellets into hollow shapes in order to reduce a flow resistance of gas while keeping a high adsorption ability of the adsorbent.

In JP-A-2013-11243, in order to form the activated carbon pellets to have hollow shapes, a meltable core is inserted into a part of each pallet at a position, where a hollow portion is to be formed. The pellets may be then heated or fired to melt the inserted cores in a manufacturing process of the activated carbon pellets. Because this technique requires the use of meltable cores, there has been a problem of an increase in the manufacturing cost of the activated carbon pellets.

In view of the challenges discussed above, there is a need in the art for a technique of forming hollow portions in activated carbon pellets without need of use of meltable cores.

### SUMMARY

In one aspect according to the present disclosure, an adsorbent may include three or more columnar portions. The three or more columnar portions may be joined to each other at their lateral sides with their axial directions extending parallel to each other such that a hollow space having opposite axial open ends and a closed lateral side closed by the lateral sides of the three or more columnar portions is defined between the three or more columnar portions. Each of three or more columnar portions may be made of a material, such as activated carbon, that is capable of adsorbing fuel vapor.

Because the adsorbent having the hollow space may be formed by three or more columnar portions that are joined to each other, it may be possible to manufacture the adsorbent without use of a meltable core.

In one embodiment, each of the three or more columnar portions may have a cylindrical shape.

With the use of three or more cylindrical columnar portions, the lateral side of the adsorbent may have convex and concave surfaces formed by the cylindrical outer side surfaces of the cylindrical columnar portions. Therefore, it may be possible to achieve an increase in a surface area usable for adsorption. Hence, it may be possible to improve an adsorption ability of the adsorbent. Furthermore, when a plurality of the adsorbents are filled within a container, such as a canister, spaces may be naturally formed between adjacent adsorbents due to the presence of the convex and concave surfaces on their laterals sides. Therefore, also in this respect, it may be possible to inhibit an increase of the resistance against flow of gas through the container.

In another embodiment, each of the three or more columnar portions may have a prism shape, such as a rectangular prism shape. With the use of the prism-shaped columnar portions, it may be also possible to improve the adsorption ability of the adsorbent and to inhibit an increase of the resistance against flow of gas when a plurality of the adsorbents are filled within a container.

In another aspect according to the present disclosure, a method of manufacturing an adsorbent may include preparing a viscous material by mixing activated carbon powder, a binder, and water, and extruding the viscous material by an extruder comprising a mandrel and a die with an opening, so that a molded body including three or more columnar portions and a hollow space is molded. The three or more columnar portions may be formed by the opening of the die, and the hollow space may be formed by the mandrel. Each of the three or more columnar portions may have a lateral side and an axial direction. The three or more columnar portions may be joined to each other at the lateral sides with the axial directions extending parallel to each other. The hollow space may be defined between the three or more columnar portions and has opposite axial open ends and a closed lateral side closed by the lateral sides of the three or more columnar portions. The method may further include firing the molded body to form the adsorbent.

With this method, the viscous material may be extruded to form a molded body, and thereafter, the molded body may be fired to form the adsorbent. Therefore, the adsorbent may be manufactured without use of a meltable core.

### BRIEF DESCRIPTION OF THE DRAWINGS

FIG. 1 is a perspective view of an activated carbon pellet according to a first embodiment;

FIG. 2 is a front view of the activated carbon pellet according to the first embodiment;

FIG. 3 is a front view of an activated carbon pellet according to a second embodiment;

FIG. 4 is a front view of an activated carbon pellet according to a third embodiment;

FIG. 5 is a front view of an activated carbon pellet according to a fourth embodiment;

FIG. 6 is an explanatory view illustrating a representative method of manufacturing the activated carbon pellet of the first embodiment; and

FIG. 7 is a sectional view taken along line VII-VII in FIG. 6.

### DETAILED DESCRIPTION

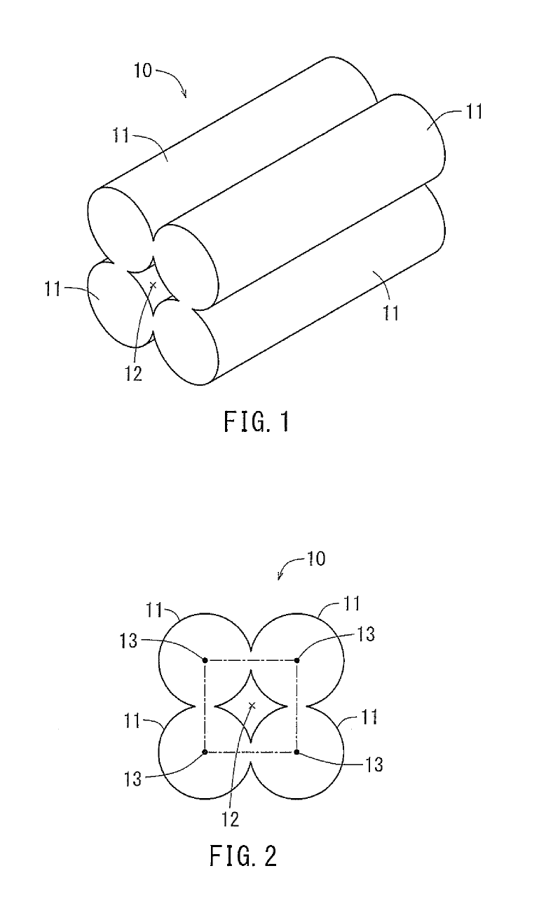

Referring to FIGS. 1 and 2, there is shown an activated carbon pellet 10 according to a first embodiment. The activated carbon pellet 10 may include four cylindrical columnar portions 11 that are arranged side-by-side with each other while their longitudinal axes extend parallel to each other. In addition, the four cylindrical columnar portions 11 are joined to each other at their lateral sides, i.e., their outer cylindrical side surfaces. A hollow space 12 may be formed between the four cylindrical columnar portions 11. The hollow space 12 may extend in an axial direction that is parallel to the longitudinal axes of the four cylindrical columnar portions 11. The lateral side of the hollow space 12 may be closed by the cylindrical side surfaces of the four cylindrical columnar portions 11, while opposite axial ends of the hollow space 12 are opened to the outside. More specifically, as shown in FIG. 2, the four cylindrical columnar portions 11 are arranged such that straight lines connecting between central axes 13 of the four cylindrical columnar portions 11 may form a square shape (i.e., a regular tetragon) as indicated by chain lines. In this way, the four cylindrical columnar portions 11 may be arranged so as to be symmetrical with each other with respect to the hollow space 12 in a plane perpendicular to the longitudinal axes 13 of the four cylindrical columnar portions 11.

A plurality of activated carbon pellets 10 may be filled within a canister (not shown) for use as adsorbent for adsorbing fuel vapor. Because each activated carbon pellet 10 has the hollow space 12, it may be possible to inhibit an increase of a resistance against flow of gas, that may be air or a mixture of air and fuel vapor, even in the event that the activated carbon pellets 10 are filled within the canister in a relatively high density. In addition, joining the four cylindrical columnar portions 11 at their lateral sides may form the hollow space 12 of the activated carbon pellet 10. Therefore, it is not necessary to use a meltable core as used in the related art. Further, the lateral side of the activated carbon pellet 10 may have convex and concave surfaces formed by the cylindrical outer side surfaces of the four cylindrical columnar portions 11. Therefore, it may be possible to achieve an increase in a surface area usable for adsorption. Hence, it may be possible to improve an adsorption ability of the activated carbon pellets 10. Furthermore, when the activated carbon pellets 10 are filled within the canister, spaces may be naturally formed between adjacent activate carbon pellets 10 due to the presence of the convex and concave surfaces on their laterals sides. Therefore, also in this respect, it may be possible to inhibit an increase of the resistance against flow of the gas through the canister filled with pellets 10.

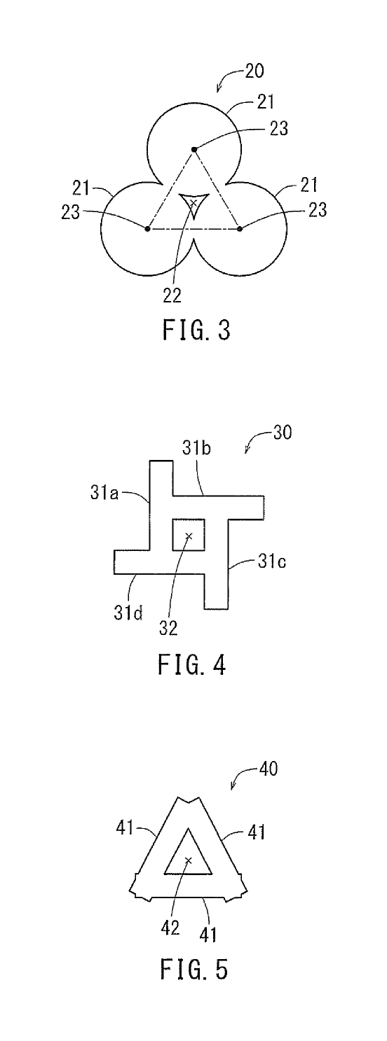

A second embodiment will now be described with reference to FIG. 3. In the first embodiment, the activated carbon pellet 10 includes four cylindrical columnar portions 11 joined to each other at their lateral sides. On the other hand, an activated carbon pellet 20 according to the second embodiment may include three cylindrical columnar portions 21 joined to each other at their lateral sides. In other respects, the second embodiment may be the same as the first embodiment.

More specifically, a hollow space 22 may be formed between the three cylindrical columnar portions 21. The hollow space 22 may extend in an axial direction that is parallel to the longitudinal axes 23 of the three cylindrical columnar portions 21. The lateral side of the hollow space 22 may be closed by the cylindrical side surfaces of the three cylindrical columnar portions 21, while opposite axial ends of the hollow space 22 are opened to the outside. More specifically, as shown in FIG. 3, the three cylindrical columnar portions 21 are arranged such that straight lines connecting between central axes 23 of the three cylindrical columnar portions 21 may form an equilateral triangle shape (i.e., a regular triangle) as indicated by chain lines.

Similar to the first embodiment, a plurality of activated carbon pellets 20 may be filled within a canister (not shown) for use as adsorbent for adsorbing fuel vapor and may achieve the same advantages as the first embodiment.

A third embodiment will now be described with reference to FIG. 4. In the first embodiment, the activated carbon pellet 10 includes four cylindrical columnar portions 11 joined to each other at their lateral sides. On the other hand, an activated carbon pellet 30 according to the third embodiment may include four rectangular prism-shaped columnar portions including a first rectangular prism-shaped columnar portion 31a, a second rectangular prism-shaped columnar portion 31b, a third rectangular prism-shaped columnar portion 31c and a fourth rectangular prism-shaped columnar portion 31d that are joined to each other at their lateral sides. In other respects, the third embodiment may be the same as the first embodiment.

More specifically, each of the first to fourth rectangular prism-shaped columnar portions 31a to 31d may have a shape like a plate having a uniform thickness. The first rectangular prism-shaped columnar portion 31a may have a flat lateral surface to which a lateral end surface of the second rectangular prism-shaped columnar portion 31b may be joined. The second rectangular prism-shaped columnar portion 31b may have a flat lateral surface to which a lateral end surface of the third rectangular prism-shaped columnar portion 31c may be joined. The third rectangular prism-shaped columnar portion 31c may have a flat lateral surface to which a lateral end surface of the fourth rectangular prism-shaped columnar portion 31d may be joined. The fourth rectangular prism-shaped columnar portion 31d may have a flat lateral surface to which a lateral end surface of the first rectangular prism-shaped columnar portion 31a may be joined. A hollow space 32 may be surrounded by the flat lateral surfaces of the first to fourth prism-shaped columnar portions 31a to 31d, so that the hollow space 32 may have a square shape (i.e., a regular tetragon) as viewed in a front view or in an axial direction of the activated carbon pellet 30.

Similar to the first embodiment, a plurality of activated carbon pellets 30 may be filled within a canister (not shown) for use as adsorbent for adsorbing fuel vapor and may achieve the same advantages as the first embodiment. Because each activated carbon pellet 30 has the hollow space 32, it may be possible to inhibit an increase of a resistance against flow of gas that may be air or a mixture of air and fuel vapor even in the event that the activated carbon pellets 30 are filled into the canister in a relatively high density. In addition, the four rectangular prism-shaped columnar portions 31a to 31d are joined to each other such that the hollow space 32 is formed therebetween. Therefore, it is not necessary to use a meltable core as used in the related art.

A fourth embodiment will now be described with reference to FIG. 5. In the third embodiment, the activated carbon pellet 30 includes four rectangular prism-shaped columnar portions 31a to 31d joined to each other to form the hollow space 32. On the other hand, an activated carbon pellet 40 according to the fourth embodiment may include three rectangular prism-shaped columnar portions 41 that are joined to each other at their opposite lateral ends. In other respects, the fourth embodiment may be the same as the third embodiment.

More specifically, each of the three rectangular prism-shaped columnar portions 41 may have a shape like a plate having a uniform thickness. Opposite lateral ends of each of the rectangular prism-shaped columnar portions 41 are joined to the lateral ends of the other two rectangular prism-shaped columnar portions 41, so that a hollow space 42 having a equilateral triangular shape (i.e., a regular triangular shape) as viewed in a front view or in an axial direction of the activated carbon pellet 40 may be surrounded by flat lateral surfaces of the three rectangular prism-shaped columnar portions 41.

Similar to the first embodiment, a plurality of activated carbon pellets 40 may be filled within a canister (not shown) for use as adsorbent for adsorbing fuel vapor and may achieve the same advantages as the third embodiment.

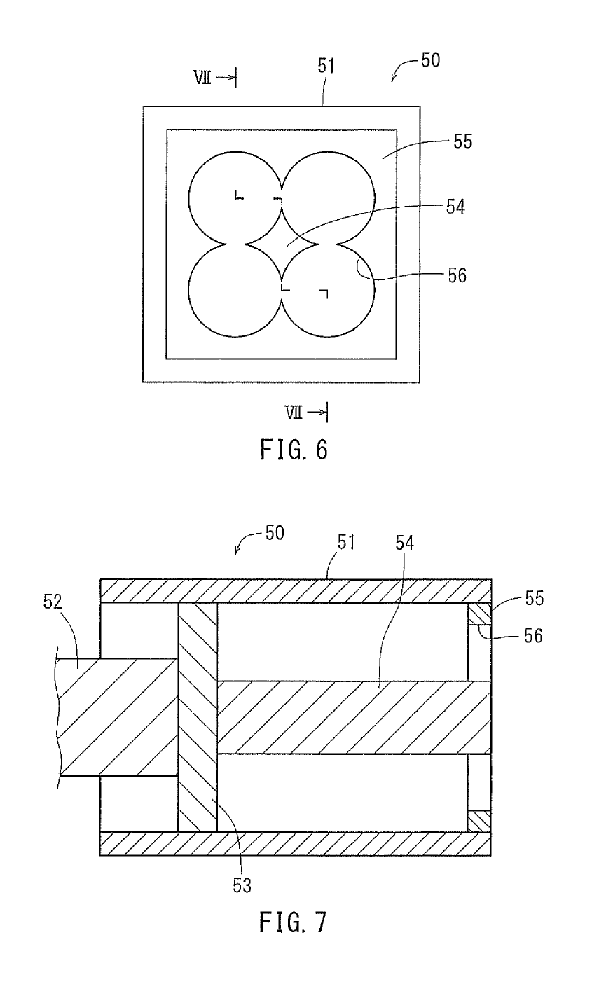

FIGS. 6 and 7 show a schematic view of an extrusion molding machine 50 that may be used for manufacturing the activated carbon pellet 10 of the first embodiment. The basic construction of the extrusion molding machine 50 may be the same as a known extrusion molding machine and will not be described in detail. The extrusion molding machine 50 may include a container 51 that may serve as a cylinder and may store an extrudable mixture. The extrudable mixture may be a viscous material and may contain activated carbon powder, water or any other suitable liquid, a suitable binder, suitable additives or fillers, etc. that are mixed with together. A die plate 55 may be attached to an outlet end of the container 51. The die plate 55 may have an opening 56. The shape of the opening 56 may conform to a cross sectional shape of an outer circumference of the activated carbon pellet 10 including the four cylindrical columnar portions 11. A dummy block 53 serving as a piston may be fitted within the container 51 for extruding the extrudable mixture toward the die plate 55. A stem 52 serving as a piston rod may be joined to the dummy block 53 for moving the dummy block 53 in an axial direction within the container 51. A mandrel 54 may be fixedly attached to the dummy block 53 within the container 51 and may extend from the dummy block 53 to a position within the opening 56, so that the hollow space 12 of the activate carbon pellet 10 may be formed by the mandrel 54.

For manufacturing the activated carbon pellet 10, a suitable amount of the extrudable mixture may be charged into the container 51 from an inlet portion (not shown) formed in the container 51. After that, the stem 52 may be axially moved by a suitable drive device (not shown) to extrude the extrudable mixture by the dummy block 53 toward the die plate 55, so that the extrudable mixture may be extruded from the opening 56 of the die plate 55. The mixture extruded from the opening 56 may have a cross sectional shape conforming to the cross sectional shape of the outer circumferential surface of the activated carbon pellet 10 (i.e., the outer circumferential surfaces of the four cylindrical columnar portions 11) to be formed. At the same time, due to the presence of the mandrel 54 at the central portion, a space corresponding to the hollow space 12 may be formed. In this way, the extruded mixture may have a shape conforming to the shape of the activate carbon pellet 10. The extruded mixture may be cut after being extruded by a predetermined distance, so that a molded body may be formed. After that, the molded body may be heated or fired to form the activated carbon pellet 10. This extruding and firing process may be repeatedly performed to manufacture a plurality of activated carbon pellets 10.

In this way, simply extruding the extrudable mixture and firing the molded body can manufacture the activated carbon pellets 10 without need of use of metal cores. Therefore, it may be possible to manufacture the activated carbon pellets 10 at a relatively lower cost.

The above embodiments may be modified in various ways. For example, although the activated carbon pellets are formed by a combination of a plurality of cylindrical columnar portions and a combination of a plurality of rectangular prism-shaped columnar portions made of the activated carbon, the activated carbon pellet may be formed by a combination of columnar portions each having an elliptical shape other than a circular shape or a polygonal shape other than a rectangular shape in a cross section. It may be also possible that the activated carbon pellet may be formed by a combination of columnar portions each having an elliptical shape or a polygonal shape other than a rectangular shape in a cross section. It may be also possible that that the activated carbon pellet may be formed by a combination of columnar portions each having a shape of a combination of a circular shape or an elliptical shape and a polygonal shape. Further, the activated carbon pellet may be formed by a combination of three or more column portions including a columnar portion(s) having a circular shape or an elliptical shape in a cross section and a columnar portion(s) having a polygonal shape in a cross section. Further, the columnar portions may be joined to each other at different positions than the lateral end portion or the lateral side surfaces. Furthermore, the column portions may be joined to each other by a suitable technique after each of the columnar portions has been formed by an appropriate molding process, such as an extrusion molding process.

The various examples described above in detail with reference to the attached drawings are intended to be representative and thus not limiting. The detailed description is intended to teach a person of skill in the art to make, use and/or practice various aspects of the present teachings and thus is not intended to limit the scope of the invention. Furthermore, each of the additional features and teachings disclosed above may be applied and/or used separately or with other features and teachings to provide improved adsorbents, and/or methods of making and using the same.

Moreover, the various combinations of features and steps disclosed in the above detailed description may not be necessary in the broadest sense, and are instead taught to describe representative examples. Further, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed as informational, instructive and/or representative and may thus be construed separately and independently from each other. In addition, all value ranges and/or indications of groups of entities are also intended to include possible intermediate values and/or intermediate entities for the purpose of original written disclosure, as well as for the purpose of restricting the claimed subject matter.

What is claimed is:

1. An adsorbent, comprising:
three or more columnar portions and each having a lateral side and an axial direction;
wherein the three or more columnar portions are joined to each other at the lateral sides with the axial directions extending parallel to each other such that a hollow space having opposite axial open ends and a closed lateral side closed by the lateral sides of the three or more columnar portions is defined between the three or more columnar portions.

2. The adsorbent according to claim 1, wherein each of three or more columnar portions is made of a material capable of adsorbing fuel vapor.

3. The adsorbent according to claim 1, wherein each of three or more columnar portions comprises activated carbon.

4. The adsorbent according to claim 1, wherein each of the three or more columnar portions has a cylindrical shape.

5. The adsorbent according to claim 1, wherein each of the three or more columnar portions has a prism shape.

6. The adsorbent according to claim 5, wherein each of the three or more columnar portions has a rectangular prism shape.

7. The adsorbent according to claim 1, wherein shapes of the three or more columnar portions are identical with each other.

8. The adsorbent according to claim 7, wherein the three or more columnar portions are arranged so as to be symmetrical with each other with respect to the hollow space within a plane perpendicular to the axial directions.

9. A method of manufacturing an adsorbent comprising:
preparing a viscous material by mixing activated carbon powder, a binder and water;
extruding the viscous material by an extruder comprising a mandrel and a die with an opening, so that a molded body including three or more columnar portions and a hollow space is molded, wherein:
the three or more columnar portions are formed by the opening of the die, and the hollow space is formed by the mandrel;
each of the three or more columnar portions has a lateral side and an axial direction;
the three or more columnar portions are joined to each other at the lateral sides with the axial directions extending parallel to each other; and
the hollow space is defined between the three or more columnar portions and has opposite axial open ends and a closed lateral side closed by the lateral sides of the three or more columnar portions; and
firing the molded body to form the adsorbent.
